(19) United States
(12) Patent Application Publication
(10) Pub. No.: US 2005/0251702 A1
(43) Pub. Date: Nov. 10, 2005

(54) Device and method for autonomous prediction network analysis

(75) Inventors: Francois Baccelli, Meudon (FR); Dohy Hong, Sous Bois (FR)

Correspondence Address: FOLEY AND LARDNER;SUITE 500, 3000 K STREET NW, WASHINGTON, DC, 20007, US

(73) Assignee: INRIA INSTITUT NATIONAL DE RECHERCHE EN INFORMATIQ UE ET EN AUTOMATIQUE

(21) Appl. No.: 10/494,966

(22) PCT Filed: Nov. 7, 2002
(86) PCT No.: PCT/FR02/03825

§ 371 Date: Jun. 15, 2005

(30) Foreign Application Priority Data
Nov. 12, 2001 (FR) 01/14608

(51) Int. Cl. G06F 11/00

(52) U.S. Cl. 714/4

(57) ABSTRACT

The invention concerns a method for testing and predicting the behaviour of a computer network. Said method consists in; a) storing a representation of the network, including routers, and a use configuration of the network including traffic classes each associated with sources; b) on the basis of the initial conditions (400), iteratively applying an additive increase and multiplicative decrease model of the traffic evolution (410, 420), to simulate an evolution of rates in the network, storing each time a set of class or source rate variables; and c) if the iteration at step b) produces a periodical orbit (430), returning to a set of class or source rate variables already encountered, examining the series of routers encountered, as responsible for losses to evaluate the rate obtained by each class or source (450).

The invention relates to surveillance and simulation of complex systems. In the context of flow control and congestion control in communication networks, notably of the Internet type, flow analysis is undertaken with a view to determining the impact of network parameters. Various proposals have been made. The most advanced of these include:
[1]—Mathis, M., Semske, J., Mahdavi, J., Ott, T. (1997) “The Macroscopic Behavior of the TCP Congestion Communication Review”, 27(3), no. 4155, July 97.
[2]—Patent WO 01/65 772 A1,
[3]—Baccelli, F. and Hong, D. “A.I.M.D., Fairness and Fractal Scaling of TCP Traffic”, Technical Report, RR-1455, INRIA Rocquencourt, April 2001,
[4]—Hong, D., Lebedev D., “Many TCP User Asymptotic Analysis of the AIMD Model”, Technical Report, RR-4229, INRIA Rocquencourt, July 2001.

[1] proposes a formula to evaluate the throughput rate of a source controlled by TCP in relation to the probability of packet loss.

[2] proposes a representation in so-called “MAX-PLUS” algebra of complex systems, such as communication networks, and notably of flow and congestion control. This “MAX-PLUS” algebra provides a means of allowing for the random character of the network parameters while considering a plurality of nodes. However, [2] considers only a single source using a TCP type protocol.

Refs. [3] and [4] propose an elementary model designed to provide an understanding of the combined evolution of throughput rates of a set of TCP sources sharing a common router. The additive increase and multiplicative decrease model (AIMD) proposed makes it possible to evaluate the performance penalty due to synchronisation of losses in the shared router. However, one parameter remains unknown: the probability function of this synchronisation.

Moreover, the models proposed are limited either to the representation of several routers and a single controlled source, or to a single router shared between several sources controlled by TCP.

In addition, the surveillance and simulation systems for these TCP controlled networks are not autonomous in terms of predicting the throughput rate obtained by the sources. That is to say they are unable to dispense with the necessity for physical observations made on a real network, such as for example the probability of losses in [1] or [2], or the synchronisation principle in [3] or [4]; in turn, they are scarcely able to cover all possible cases with a reasonable degree of reliability, notably in a wide area network.

The invention aims to improve this situation.

The invention relates to a method for testing and predicting the behaviour of a computer network including the following steps:
a) storing a representation of the network on one hand, including routers, their particular transmission properties, and transit times between routers, and a usage configuration of the network on the other hand, including traffic classes, with a number of sources and a path through the routers being assigned to each traffic class,
b) on the basis of selected initial conditions, iteratively applying a traffic evolution model, of the additive increase and multiplicative decrease type, to simulate the evolution of throughput rates in the network, in each instance storing a set of class or source rate variables, and
c) if the iteration at step b) produces a periodic orbit, reverting substantially to a set of class or source rate variables already encountered, examining the series of routers encountered, as responsible for losses to evaluate the rate obtained by each class or source.

The invention also relates to a device for testing and predicting the behaviour of a computer network.

In a principal characteristic of the invention, the device includes
a memory designed to store:
   parameters of the network including routers, their specific transmission properties, and transit times between routers,
   usage configuration parameters of the network including traffic classes, each of these classes being associated with a number of sources and a path through the routers,
   a calculation module based on a traffic evolution model of the additive increase and multiplicative decrease type,
a processing module designed:
   on the basis of selected initial conditions, to iteratively apply a traffic evolution model, of the additive increase and multiplicative decrease type, to simulate the evolution of throughput rates in the network, in each instance storing a set of class or source rate variables,
   to halt the iterative application of the traffic evolution model when a periodic orbit reverung substanually to a set of class or source rate variables already encountered is obtained,
   to examine the series of routers encountered as responsible for losses to evaluate the rate obtained by each class or source.

Other characteristics and advantages of the invention will become apparent upon reading the following detailed description together with the attached drawings in which:

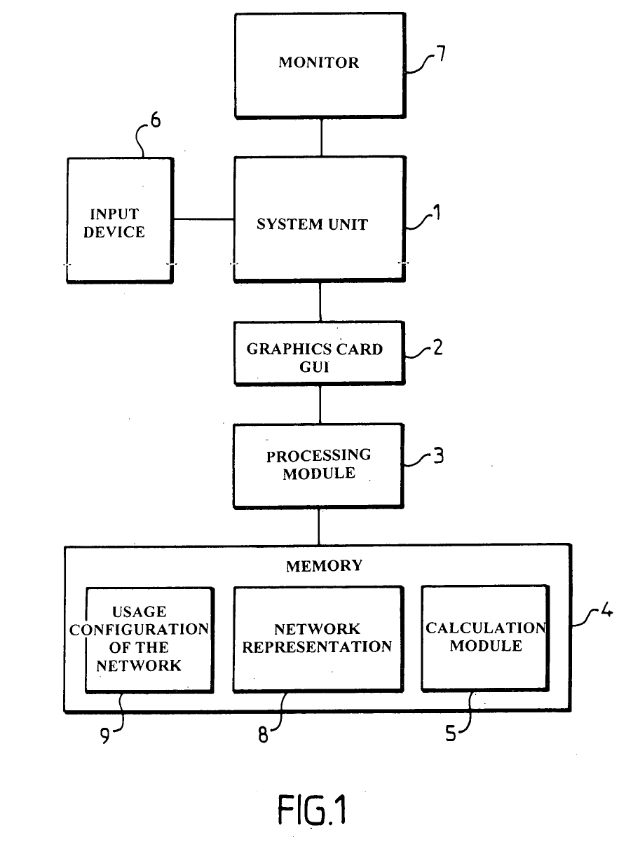

FIG. 1 illustrates a computing device including a processing module according to the invention,

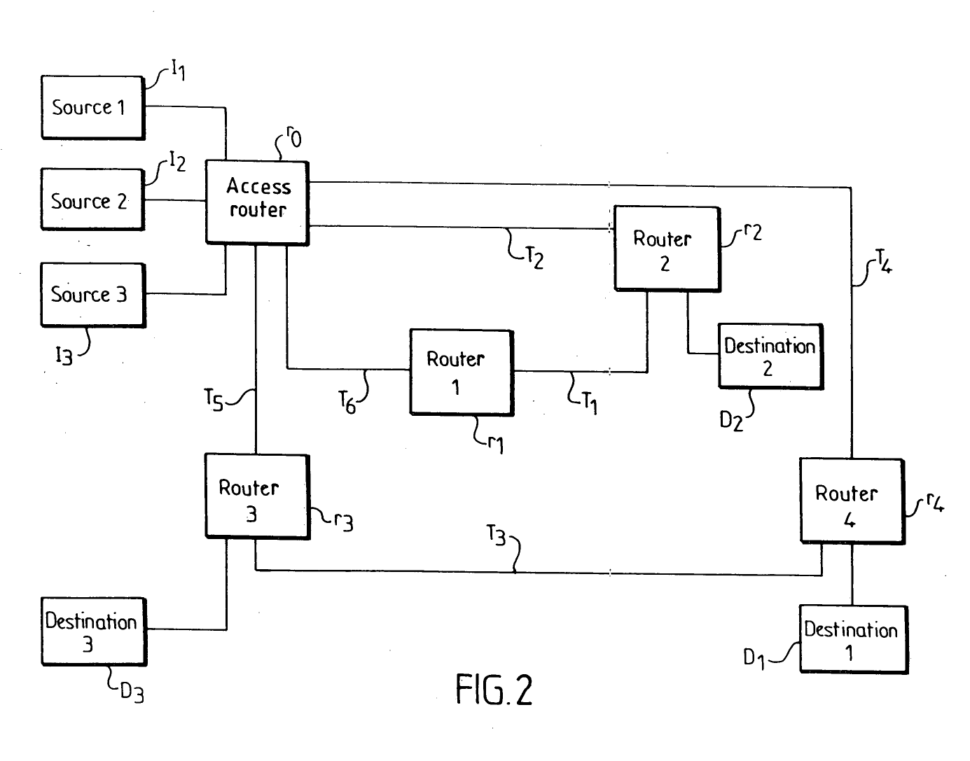

FIG. 2 illustrates a computer network composed of routers shared between a set of sessions,

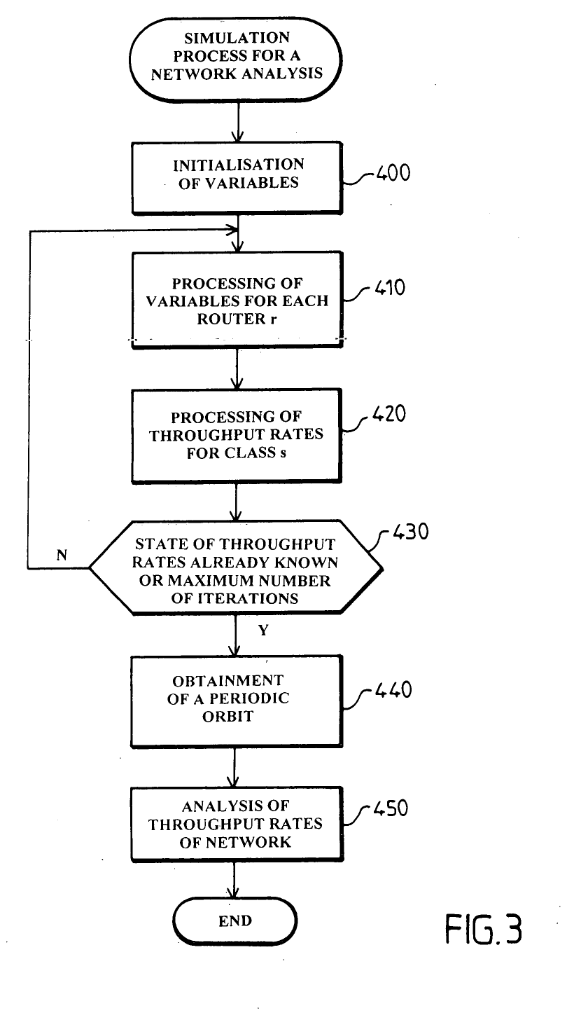

FIG. 3 is a flow diagram of the simulation process for a network analysis according to the invention,

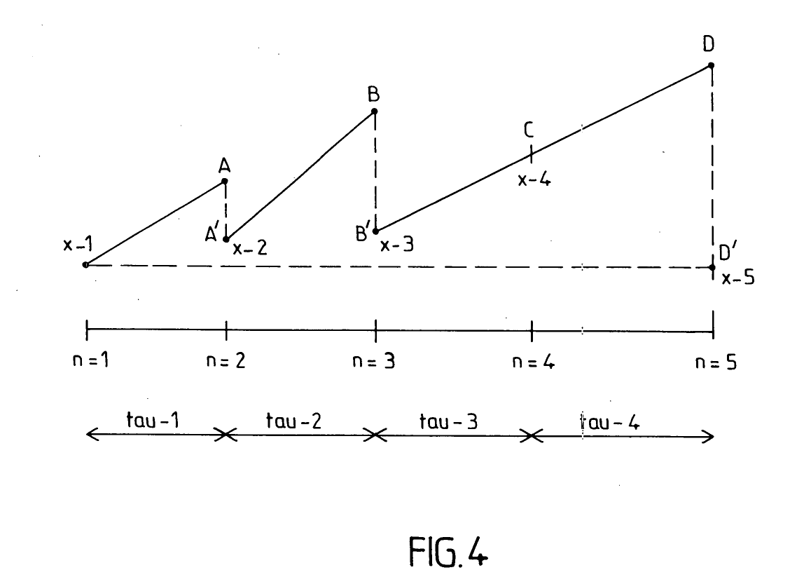

FIG. 4 is a graph showing the pattern of average throughput rate in a router belonging to the path of a class.

Appendix A gives the network parameters, source parameters and variables of the model to which the following description refers.

Appendix B gives the computation steps for the algorithms associated with a model to which the following description refers.

Appendix C gives estimates of the synchronisation rate based on certain assumptions.

Appendix D gives the mathematical formula to which the following description refers.

The drawings and the appendices essentially contain elements that are certain in character. They will therefore serve not only to assist understanding of the description, but also contribute to the definition of the invention, as applicable.

The description below refers to publication [2] in respect of the type of additive increase and multiplicative decrease (AIMD) model used. This elementary model is used to represent the combined evolution of throughput rates of a set of TCP sources sharing a common router in a computer network.

In the description, the notation v[j] designates a table variable or vector (“array”) having a value for each value of j. A variable with two dimensions v[i,j] will be referred to as a matrix.

FIG. 1 illustrates a computing environment including a system unit 1 connected to a monitor 7 and an input device 6 such as a keyboard or mouse. The system unit 1 is also connected to a graphics card GUI 2 set up to handle the display of data on the monitor 7. According to the invention, the system unit 1 is capable of working in conjunction with the processing module 3 connected to the memory 4. The memory 4 stores data relating to the network representation 8 and data 9 relating to the usage configuration of the network. These data will be described in more detail below. The memory 4 includes a calculation module 5 which works in conjunction with the processing module 3. This processing module 3 is designed to iteratively apply a traffic evolution model, of the additive increase and multiplicative decrease type, to simulate the evolution of throughput rates in the network routers. At each application, the processing module is designed to request the storage of a set of network rate variables so as to be in a position to predict the next period of congestion and to remedy the congestion anticipated.

The description relates notably to the prediction of flow performance, for example TCP flows, and the quantity of service (QoS) in a multi-router topology. In other words, the device and the method of the invention are used, inter alia, when a large number of sources controlled by a protocol, of the TCP type for example, share several routers. This simulation is based on a fluid description of the additive increase and multiplicative decrease (AIMD) type model.

FIG. 2 illustrates a computer network of the type used in the invention. Thus, the network is composed of several routers r0, r1, r2, r3 and r4, router r0 being an access router. The routers are interconnected by links such that T1 connects r0 to r3, t2 connects r0 to r2, T3 connects r3 to r4, T4 connects r0 to r4, T5 connects r3 to r4, T6 connects r0 to r1.

A number of sources 1, 2, 3 referenced I1, I2, I3 and destinations 1, 2, 3 referenced D1, D2, D3 are shown in FIG. 2. The sources are connected to the network via the access router r0. The destinations are connected to the network via an access router r4, r2, r1 respectively.

The present description uses the concept of classes (of traffic). It will be assumed for the moment that a class is defined by a pathway and by certain properties of the transmission that can travel on this pathway.

Different pathways can be taken to connect a source to a destination. The same pathway can be associated with different classes. A pathway is associated with a “type” of class. A class “type” corresponds to the set of classes defining the pathway or the same end-to-end path of a class (Appendix A2-3). Thus, for a pathway connecting one of the sources S to D1, at least two class types are defined, the class type defining the pathway (T4) and the class type defining the pathway (T5, T3) and passing through intermediate router r3. For a pathway connecting one of the sources S to D2, at least two class types are also defined, the class type defining the pathway (T2) and the class type defining the pathway (T1, T2) and passing through intermediate router r2. For a pathway connecting one of the sources S to D3, at least two class types are again defined, the class type defining the pathway (T5) and the class type defining the pathway (T4, T3) and passing through intermediate router r4.

A class is defined by a pathway, a session type, propagation times, and a number of sources. In reference to Appendix A2, a class can be defined for example by the dataset ST,SN,SR,SB,SE. More explicitly, in a given class ‘s’, if SN[s]=100, 100 sources belonging to the class V have the same characteristics as follows:
same session type FTP (File Transfer Protocol) or HTTP (Hyper Text Transfer Protocol),
same end-to-end path, therefore in particular the same round-trip time denoted by RTT(=rtt[s]) (Appendix A3-4).

In the remainder of the description, the classes are designated by the variable s and the routers are designated by the variable r. The same source can be designated as a source of class s and a source of class s′ if the classes s and s′ each define a pathway running from the same source to the same destination as previously illustrated but having a different session. Furthermore, there are several sources for the same class, i.e. several sources that have an identical pathway to reach their destination.

The term “congestion epoch n” denotes an instant n at which the throughput rates of each class s are computed (rates equal to the rate of each source i of class s). This “congestion epoch n” also denotes an instant at which a network router is said to be “congested” or in a “state of congestion”, i.e. a router which will experience one or more packet losses.

In reference to part A1 of Appendix A, the network parameters designate the parameters of the routers defined in A1-1, A1-2, A1-3, A1-4, A1-5. Thus the routers, defined by their capacity to handle packet throughput rates, can include a buffer memory or buffer, which has the role of holding part of the incoming flow in excess of the outgoing flow. In the absence of buffer memory for a router r, the size of the buffer memory of the routers is null B[r]=0. The routers can be of different types such as for example:
FIFO (First In First Out) or FQ (Fair Queuing) designating the types of routers liable to lose packets overflowing the queue, also referred to as Tail Drop,
RED (Random Early Detection) designating types of routers capable of discarding packets in advance when the queues overflow.

In the example traffic evolution model of the additive increase and multiplicative decrease (AIMD) type, the variables are defined in reference to part A3 of Appendix A.

FIG. 3 illustrates an example embodiment of the simulation process for a network analysis according to the invention. The process refers to Appendices A, B, C and D in relation to the AIMD traffic evolution model proposed in the example.

Thus, at step 400 and in reference to part B0 of Appendix B, certain variables of the model are initialised:
at B0-1, each element of the matrix p[s,r] denotes a probability of synchronisation of packet losses, referred to as the synchronisation rate defined between 0 and 1 which in this case is assumed to be pre-defined according to Bernoulli's law. The value of the random variable gamma[s,r] equal to 0.5 denotes a “heads or tails” type probability law,
at B0-2, each element of the vector c[r] denotes the capacity (in packets per second) that a source can have from a router if the total capacity of this router were ideally shared between the sources using this router r,
at B0-3, each element of the matrix a[s,r] denotes a proportion of the number of class s sources relative to the number of sources using the router r,
at B0-4, each element of the vector m-rrt[r] will denote the sum on s of the elements a[s,r] each divided by their minimum round-trip time in the class considered squared,
at B0-5, each element of the matrix g[s,r] denotes an integer between 0 and 1 calculated in relation to the synchronisation rate,
at B0-6, the initialisation phase involves initialising the average throughput rates for all classes and for all congestion epochs n varying from 1 to N (n and N being integers) with the given function F( ) describing the initial condition. This function can be such that, for example, f(s)=0 for any class s. There is one constraint on f( ): this function must be such that for any ‘r’, tau_1 [r] at step 1 as defined in Appendix B0 must be positive or null.

This means that the initial load must be compatible with the capacity of network.

Formulation B0-1 is predefined in the case where the following assumption is made:
the routers have a buffer memory of null size.

Furthermore, in the example embodiment of the process, at A1-5 the type of router used is of the FIFO type, and at A2-2 the session type is FTP.

Steps 410, 420, 430 represent the iteration per Appendix B1-0 in each congestion period for steps 1, 2 and 3 defined below.

At step 410, processing of variables is performed for each router r. Thus, step 1 in Appendix B1-1 defines, for each router r at a congestion epoch n, a sum of class source rates for all classes based on the congestion period n-1. Thus, som_n[r] represents the total load (or rate) on the router ‘r’ at the end of the previous iteration (at the first iteration, som_1[r] represents the total load on the router ‘r’ defined by the initial condition). The calculation of tau-n[r] defines a time between the given congestion epoch n-1 and the consecutive congestion epoch n, referred to as the virtual inter-congestion time for each router R. In other words, tau_n[r] is the virtual duration of inter-congestion of router ‘r’ which would be effective if for example all the other routers were of infinite capacity (c[r]).

Step 2 in Appendix B1-2 is used to determine the minimum inter-congestion time in the set of virtual inter-congestion times of the routers r, also referred to as the network inter-congestion time tau_n. This minimum inter-congestion time designates the time between the old congestion epoch and the current congestion epoch. In other words, the value of tau_n gives the n- the inter-congestion time of the network.

At step 420, average throughput rates are processed for each class s. Thus, at step 2 in Appendix B1-2, the current average throughput x_n[s] for each class s in the n-th congestion epoch is calculated at (1). (1) applies the mechanism of linear increase (AI described in the documents presenting the AIMD model) to all the sources. The absolute date of the n-th congestion of the network is given by the value of temps_n.

For the router, termed the n-th router or congested router at instant n, whose virtual inter-congestion time is equal to the inter-loss time of the network and which belongs to the class pathway (also referred to as the end-to-end pathway of the class), the new average throughput rate x_n[s] of each class s defined at the congestion epoch n is then calculated in (2) at step 3 of Appendix B1-3. This new calculated average rate x_n[s] is lower than the previous average rate to avoid congestion, packet loss or other problem at the congested router(s) during congestion epoch n. The new average rate x_n[s] is calculated in relation to the synchronisation rate and the corresponding old average rate. (2) in Appendix B1-3 applies the multiplicative decrease (MD) mechanism of the AIMD mechanism as an average to the sources passing through the congested router.

At step 430, a check is made to determine whether the calculated rates match a throughput status already encountered previously or whether the number of iterations at steps 410 and 420 has reached a specified number of iterations (number defined by the variable Max_iter at step 0 in B1-0). If a negative response is obtained, the iteration of steps 410 and 420 is continued to determine the next minimum inter-virtual time of the routers and the corresponding throughput rates. This iteration of steps 410 and 420 illustrates the mathematical formula of Appendix D including sums of the classes to compute the inter-congestion time of a router, a minimum to be found from the inter-congestion times of the routers, these operations being repeated for each congestion epoch. The average throughput rates are thus computed by virtue of the synchronisation matrix represented by γₙ₊₁.

If a positive response is obtained at step 430, the vectorial recurrence equation has a solution (given certain assumptions) which is a periodic orbit at step 440. The theory ensures the uniqueness and the existence of such a finite orbit. In effect, if congestion events (causing losses) occur infinitely often on each router, there is a unique solution to the equation in Appendix D, which has a finite period n independent of the initial conditions of the vector x_n[]. This solution is defined as a so-called periodic orbit in that it will be found in the case of a new cycle of iterations. This orbit is characterised by a finite series of the type B1-4 in which r_n is the series of routers where congestion has occurred (causing packet loss or losses), x_n[s] is the series of average rates of class s, tau_n is the series of inter-congestion times of the network, the series being defined at n congestion epochs. This discrete-time orbit completely defines the continuous trajectory by linearisation of the rates defined in Appendix B1-5. It defines the ‘skeleton’ of the instantaneous rate process.

In a variant of the invention, this orbit can be determined using a traffic evolution model other than the additive increase and multiplicative decrease model.

At step 450, the average rates are analysed. Thus, at this step, instantaneous throughput rates are computed using a stochastic approach if the number of sources per class is high (SN). In this case, the instantaneous throughput rates are computed from the series of average rates obtained. The instantaneous rates x_n[s,i] are computed using formula B2-1 in which the inter-congestion time of the network at the instant n is added to the previous instantaneous rate x_{n-1}[s,i], this being done for each class s and for each source i. For each router in the series r-n included in the pathway defined by a class s SR[s], the new instantaneous rate x_n[s,i] is calculated using formula B2-2. The random variable gamma[s,r] corresponds to the ratio of the rates x_n[s,i] immediately after and before congestion.

It is thus possible to determine the evolution of instantaneous rates in each class and thereby predict the performance of the network.

When a periodic orbit is found before a maximum number of iterations, Max_iter, the results for steady-state mode are derived from processing of the orbit thus obtained. The results for transient mode (for example the time required to attain steady-state mode) can also be obtained. If the iteration stops when a maximum number of iterations is reached, Max_iter, without a periodic orbit being found, it is possible to visually observe whether the steady-state mode has been approximately attained by tracing the evolution of x_n. In the case where this visualisation is difficult, a transient mode is obtained which can still be processes. In this case also, the convergence time to steady-state mode is greater than the simulation time temps_{Max_iter}.

A typical value for the maximum number of iterations is between 10³ and 10⁶ depending on the size of the network and the number of sources.

In FIG. 4, the graph of the variation in average rate x in a router belonging to the pathway of a class s is an illustration of average rates computed for a number of iterations equal to 4. At congestion epoch n=1, the average rate of class s is x-1. At congestion epoch n=2, the average rate at point A is computed. In the example, the virtual inter-congestion time of the router in question is equal to the inter-congestion time of the network between congestion epochs 1 and 2. Thus, for this router belonging to the pathway of the class s in question, at congestion epoch n=2, the average rate x-2 of the router is computed in relation to the synchronisation rate and corresponds to point A′.

At congestion epoch n=3, the average rate at point B is computed. In the example, the virtual inter-congestion time of the router in question is equal to the inter-congestion time of the network between congestion epochs 2 and 3. Thus, for this router belonging to the pathway of the class s in question, at congestion epoch n=3, the average rate x-3 of the router is computed at point B′ in relation to the synchronisation rate.

At congestion epoch n=4, the average rate at point C is computed. In the example, the virtual inter-congestion time of the router is not equal to the inter-congestion time of the network between congestion epochs 3 and 4. Thus, for this router belonging to the pathway of the class s in question, no congestion (resulting in packet loss) occurs, and the average rate x-4 is that computed at point C.

At congestion epoch n=5, the average rate at point D is computed. In the example, the virtual inter-congestion time of the router in question is equal to the inter-congestion time of the network between congestion epochs 4 and 5. Thus, at congestion epoch n=5, for this router belonging to the pathway of the class s in question, the average rate of the router is computed at point D′ in relation to the synchronisation rate.

As this average rate x-5 is equal to average rate x-1, and the same applies to the other classes to which this router belongs and to other routers in the network, a set of average rate values defines the periodic orbit sought.

A variant of the flow diagram given in FIG. 3 will now be described in reference to Appendices B3 and B4. The proposed algorithm is a direct procedure for computing instantaneous rates in the case where the number of sources per class SN is a small value, i.e. a value lower than a hundred sources.

Thus, the initialisation of instantaneous rates is carried out at step 0 in Appendix B3. Each instantaneous rate x-n[s,i] takes the value of a function F(s,i). This value is either a given fixed value or a value obtained by random selection. As previously, the iteration in Appendix B4-0 corresponds to the iteration of steps 1, 2 and 3 in Appendices B4-1, B4-2, B4-3. In this alternative embodiment, there is no wait until a periodic orbit is obtained. The value of the maximum number of iterations Max_iter varies, for example according to the length of time for which the network (temps_{Max_iter}) is analysed or in relation to practical constraints such as the simulation time. As previously, “a posteriori” visual graphic observation gives some idea as to whether or not a steady-state mode has been attained.

Thus, step 1 in Appendix B4-1 computes the virtual inter-congestion times of each router, the rates x_n being stochastic (at 0b). Step 2 in Appendix B4-2 computes the virtual inter-congestion time of the network and, at (1b) the current instantaneous rate x_n[s] of each class s at the n-th congestion epoch. (1b) applies the mechanism of linear increase (AI described in the documents presenting the AIMD model) to all the sources.

At step 3 in Appendix B4-3, the multiplicative decrease element (MD) of the AIMD mechanism is applied to the instantaneous rates of the sources passing through the congested router (at 2b).

A further variant of the flow diagram given in FIG. 3 will now be described in reference to Appendices B5 and B6. Like algorithm 2 in reference to Appendices B3 and B4, algorithm 3 in Appendices B5 and B6 is a direct procedure for computing instantaneous throughput rates where the number of sources per class SN is a small value and corresponds to the case of a non-negligible buffer memory (B[]>0).

Algorithm 3 corresponds to algorithm 2 in which algorithm elements preceded by an asterisk have been added. The following variables have also been added relative to the buffer memory of the routers:
bb_n[r]: intermediate queue size at step n.
bn_n[r]: queue size of router ‘r’ at step n.
tau0_n[r] represents the tau_n[r] of algorithm 2, i.e. the virtual inter-congestion time obtained if the other routers are of infinite capacity c[r] and if the router ‘r’ in question has no buffer memory (buffer).

Thus, at step 0 in Appendix B5, the algorithm elements added to algorithm 2 are the zero initialisations of queue sizes bb_n[r] and bn_n[r].

At step 1 in Appendix B5-1, the computation of the virtual inter-congestion time of a router at congestion epoch n takes into account the virtual inter-congestion time of the router without buffer memory and the calculation of the intermediate queue size of the router.

At step 2 in Appendix B5-2, after computing the inter-congestion time of the network tau_n at the congestion epochs n and updating the rates, the queues bn-n[r] are updated depending on whether or not, for a congestion epoch n and a given router, the inter-congestion time of the network is greater than the time tau0_n[r].

Other embodiments of the invention are envisaged below.

Thus, instead of being predefined, the synchronisation rate is estimated in the following description. Several estimates are possible.

Assuming that synchronisation is independent of throughput rate (case RI), an approximation of synchronisation rate of the type C1-1 can be made, L being the probability of packet loss over a duration of delta[s,r] starting from a full buffer memory (buffer), delta being the reaction time of the protocol, TCP for example, to a loss. This formula is obtained by the approximation that the ratio B[r]/C[r] is well below the average value of the virtual inter-congestion times tau_n[r] for each router, in other words B[r]/C[r]<<average of (tau_n[r]).

When an incoming rate to a router is practically equal to the outgoing rate from the same router, and when the size of the buffer memory B[r] is negligible, the variables of the formulation C1-1 are computed as follows:
the probability L of packet loss is computed according to C1-2 and
delta[s,r] is computed as a proportion of the round-trip time rtt[s] of a class s which depends on the position of the router r.

When the input rate of a router is different from the output rate of the same router, and when the size of the buffer memory B[r] is not negligible, the variables of formulation C1-1 are computed as follows:
a modification must be applied to L such as that proposed in C3-1, where rho represents the ratio of the input rate of a router to the output rate.

In the case where synchronisation is independent of rate, the random variable gamma[s,r] is determined for example in accordance with Bernoulli's law as previously seen. Assuming that synchronisation is dependent on rate (case RI), the synchronisation rate is computed by an approximation of the type C2-1.

In all estimation cases, the synchronisation rate is estimated for each router and for each class to which this router belongs. In all estimation cases, the random variable gamma[s,r] is determined, for example, in accordance with a linear model, or a model as a function of rate in an exponential or polynomial manner.

The method described assumes that the network parameters and the parameters of each TCP source are given.

The device and the corresponding method can have the following typical applications.

One direct application is the prediction of the performance of the connection for a typical user in a given network configuration. The performance sought is, for example, the average rate obtained by a user, and more generally a guaranteed rate for a certain percentage of the connection time, a loss rate, or any other values which depend of the temporal fluctuation of the instantaneous rate. Another direct application is the implementation of an optimised TCP traffic generator.

Other indirect applications derive from the first of the previous applications. Thus, the local architecture can be optimised for a fixed performance objective by:
optimal sizing of the router capacity,
optimal sizing of the buffer memory.

The following can also be optimised:
geometrical disposition of the routers (hierarchical structure),
choice of connectivity for the routers (hierarchical or peer-to-peer),
understanding and diagnostics of the overall architecture by classifying the routers according to their performance, and the location of “bottleneck” type routers.

The invention covers the software product including the functions used in the test process. The invention also covers the software product defining the elements of the processing module of the device according to the invention.

It is to be understood that the invention is not limited to the form described above but extends to other alternative embodiments.

Thus, in another embodiment of the invention, the sources are of the HTTP type. In an alternative embodiment, the synchronisation rate is directly estimated by independent simulation. In another embodiment, the routers are of the fair queuing (FQ) type.

This simulation can also be applied to applications other than computer networks, for example any type of network topology in a variety of fields (road network, waterway network, etc.).

### Appendix A

A1. Network Parameters

A1-1 N_Router: number of routers;

A1-2 C[N_Router]: capacity of routers (unit in packet/s);

A1-3 B[N_Router]: buffer size of routers (unit in packet/s);

A1-4 L[N_Router][N_Router]: transmission time (pure propagation);

A1-5 RT[N_Router]: router type: FIFO, FQ, RED, etc.

A2. Class Parameters

A2-1 N_Classe: class number of sources;

A2-2 ST[N_Classe]: session type, FTP or HTTP, of the class;

A2-3 SN[N_Classe]: number of sources per class;

A2-4 SR[N_Classe]: end-to-end path of a class;

A2-5 SB[N_Classe]: propagation time (source)-(access router);

A2-6 SE[N_Classe]: propagation time (terminal access router)-(destination);

A3. Description of Model Variables

A3-1 X_n[s,i]: instantaneous rate of source ‘i’ of class ‘s’ at the n-th iteration;

A3-2 x_n[s,i]: average rate of source ‘i’ of class ‘s’ at the n-th iteration;
x_n[s,i] is independent of ‘i’: it is stated x_n[s]=x_n[s,i]

A3-3 N[r]: number of sources using the router ‘r’;

A3-4 rtt[s]: round-trip time of the class ‘s’;

A3-5 tau_n: n-th inter-congestion time of the network;

A3-6 tau_n[r]: n-th virtual inter-congestion time of the router ‘r’;

A3-7 gamma[s,r]: random variable of synchronisation;

APPENDIX B
B0. Initialisation

| | | |
|---|---|---|
| B0-1 | p[s,r] | := P(gamma[s,r] = 1/2); |
| B0-2 | c[r] | := C[r]/N[r]; |
| B0-3 | a[s,r] | := SN[s]/N[r], if ‘r’ in SR[s]; |
| | | = 0 else; |

| | |
|---|---|
| B0-4 | m_rtt[r] := sum s a[s,r]/rtt[s]/rtt[s]; |
| B0-5 | g[s,r] := 1 − p[s,r] / 2; |
| B0-6 | Step 0 |
| | n = 0; |
| | temps_n = 0; |
| | for (s=0;s<N_Classe;s++) |
| | x_n[s]:= f(s); |

B1. Iteration

| | |
|---|---|
| B1-0 | for (n=1;n<Max_iter;n++) { |
| | do Step1(n); |
| | do Step2(n); |
| | do Step3(n); |
| | } |
| B1-1 | Step 1 |
| | for (r=0;r<N_Router;r++) { |
| | som_n[r] = 0; |
| | for (s=0;s<N_Classe;s++) |
| | som_N[r]+= a[s,r] * X_{n−1}[s]; |
| | tau_n[r]:= (C[r] − som_n[r])/ (m_rtt[r]); |
| B1-2 | Step 2: |
| | tau_n:= min_{r=0..N_Router} (tau_n[r]); |
| (1) | x_n[s]:= x_{n−1}[s]+tau_n/rtt[s]/rtt[s]; |
| | temps_n:= temps_{n−1} + tau_n; |
| B1-3 | Step 3: |
| | if (tau = tau[r] and ‘r’ in SR[s]) |
| (2) | x_n[s]:= g[s,r] * x_n[s]; |
| B1-4 | {r_n, x[s]_n, tau_n} |
| B1-5 | x_n[s] |
| | x_n[s]+tau_{n+1 }/rtt[s]/rtt[s] |

B2. Algorithm 1

| | |
|---|---|
| B2-1 | X_n[s,i]:= (X_{n−1}[s,i] + tau_n/rtt[s]/rtt[s] ); |
| B2-2 | if ( ‘r_n’ in SR[s] ) |
| | X_n[s,i]:= gamma[s,r] * X_n[s,i]; |

B3. Algorithm 2 - Initialisation

Step 0
n = 0;
temps_n=0;
for (s=0;s<N_Classe;s++)
for (i=0;i<SN[s];i++)
X_n[s,i]:= F(s,i);

B4. Algorithm 2

| | |
|---|---|
| B4-0 | for (n=1;n<Max_iter;n++){ |
| | do Step1(n); |
| | do Step2(n); |
| | do Step3(n); |
| | } |
| B4-1 | Step 1 |
| | for (r=0;r<N_Router;r++) { |
| | som_n[r] = 0; |
| | for (s=0;s<N_Classe;s++) { |
| | x_{n−1}[s] = 0; |
| | if (‘r’ in SR[s]) { |
| | for (i=0;i<SN[s];i++) |
| | x_{n−1}[s] + = X_{n−1} [s,i]; |
| (0b) | x_{n−1}[s] /= SN[s]; |
| | } |
| | som_n[r] += a[s,r]*x_{n−1}[s]; |
| | } |
| | tau_n[r]:= (c[r] − som_n[r]) / (m_rtt[r]); |
| | } |
| B4-2 | Step 2 |
| | tau_n:= min_{r=0..N_Router} (tau_n[r]); |
| (1b) | X_n[s,i]:= X_{n−1} [s,i] +tau_n / rtt[s] / rtt[s]; |
| | temps_n:= temps_{n−1} + tau_n; |
| B4-3 | Step 3 |
| | if (tau=tau[r] and ‘r’ in SR[s]) |
| (2b) | X_n[s,i]:= gamma[s,r] * X_n[s,i]; |

B5. Algorithm 3 - Initialisation

| | |
|---|---|
| | Step 0 |
| | n = 0; |
| | temps_n = 0; |
| | for (s=0;s<N_Classe;s++) |
| | for(i=0;i<SN[s];i++) |
| | X_n[s,i]:= F(s,i); |
| * | for (r=1;r<N_Router;r++){ |
| * | bb_n[r]:= 0; |
| * | bn_n[r]:= 0; |
| * | } |

B6. Algorithm 3

| | |
|---|---|
| B6-0 | for (n=1;n<Max_iter;n++){ |
| | do Step1(n); |
| | do Step2(n); |
| | do Step3(n); |
| | } |
| B6-1 | Step 1 |
| | for (r=0;r<N_Router;r++) { |
| | som_n[r] = 0; |
| | for (s=0;s<N_Classe;s++) { |
| | x_n{n−1}[s] = 0; |
| | if (‘r’ in SR[s] ) { |
| | for (i=0;i<SN[s];i++) |
| | x_{n−1}[s] += X_{n−1}[s,i]; |
| | x_{n−1}[s] /= SN[s]; |
| | } |
| | som_n[r] += a[s,r] * x_{n−1}[s]; |
| | } |
| * | tau0_n[r]:= (c[r] − som_n[r]) / (m_rtt[r]); |
| * | bb_n[r]:= MAX(0,bn_{n−1}[r]−tau0_n[r]*tau0_n[r]/ |
| | 2*m_rtt[r]); |
| * | tau_n[r]:= tau0_n[r]+sqrt(2/m_rtt[r]*((double)B[r]/ |
| | N[r]−bb_n[r])); |
| * | } |
| B6-2 | Step 2 |
| | tau_n:= min_{r=0..N_Router} (tau_n[r]); |
| | X_n[s,i]:= X_{n−1}[s,i] + tau_n / rtt[s] /rtt[s]; |
| | temps_n:= temps_{n−1} + tau_n; |
| * | for (r=0;r<N_Router;r++) |
| * | if ( tau_n > tau0_n[r] ) |
| * | bn_n[r]:= bb_n[r] + pow(tau_n−tau0_n[r],2)/2*m_rtt[r]; |
| * | else |
| * | bn_n[r]:= MAX(0,bn_{n−1} [r]−pow(tau_n,2)/2*m_rtt[r]); |
| * | } |
| B6-3 | Step 3 - idem B4-3 |

### Appendix C

C1. Estimation of Synchronisation Rate Independent of Throughput Rate (Case RI)
C1-1 p(RI)[s,r]:=(1−exp(−C[r]*delta[s,r]*L/N[r]))/(1−exp(−C[r]*delta[s,r]*L));
C1-2 L=1/(B[r]+1)

C2. Estimation of Synchronisation Rate Dependent on Throughput Rate (Case RD)
C2-1 p(RD)[s,r]:=p(RI)[s,r]*x_{—}n[s]/som[r];

C3. Probability of Loss L in the Case of a Non-Negligible Buffer Memory
C3-1 L=rho\hat{ }B[r]*(rho−1)/(rho\hat{ }(B[r]+1)−1);

### Appendix D

$${x}_{n + 1}^{( s )} = {\overline{γ}}_{n + 1}^{( {r}_{n + 1} , s )} [ {x}_{n}^{( s )} + \frac{1}{{R}_{s}^{2}} {min}_{r ∈ ℛ} \frac{{c}_{r} - {\sum }_{u : r ∈ {P}_{u}} {a}_{u , r} {x}_{n}^{( u )}}{{\sum }_{u : r ∈ {P}_{u}} \frac{{a}_{u , r}}{{R}_{u}^{2}}} ]$$

1. Method for testing and predicting the behaviour of a computer network characterised by the following steps:
a) storing a representation of the network (8) on one hand, including routers (r), their particular transmission properties (C, A1-2), and transit times between routers, and a usage configuration of the network (9) on the other hand, including traffic classes, with a number of sources (SN, A2-3) and a path through the routers (SR, A2-4) being assigned to each of these classes,
b) on the basis of selected initial conditions (400), iteratively applying a traffic evolution model (410, 420), of the additive increase and multiplicative decrease type, to simulate the evolution of throughput rates in the network, in each instance storing a set of class or source rate variables, and
c) if the iteration at step b) produces a periodic orbit (430), reverting substantially to a set of class or source rate variables already encountered, examining the series of routers encountered, as responsible for losses to evaluate the rate obtained by each class or source (450).

2. Method according to claim 1, characterised in that step c) is also carried out when the number of iterations of step b reaches a threshold (430).

3. Method according to either of claims 1 and 2, characterised in that step b) includes
b1) computation and storage of a virtual inter-congestion time (tau_n[r], A3-6) for each router.

4. Method according to claim 3, characterised in that step b1) also includes computation of a minimum virtual inter-congestion time, as the effective inter-congestion time of the network (tau_n, A3-5).

5. Method according to either of claims 3 and 4, characterised in that step b) also includes:
b2) at each given instant, computation and storage of at least one rate of a class of which the pathway passes through a congested router (x_n[s], x_n[s]).

6. Method according to claim 5, characterised in that the congested router at step b2) is selected so that it verifies a given condition, which includes the fact that the inter-congestion time of the network (tau_n, A3-5) is equal to the virtual inter-congestion time (tau_n[r], A3-6) for this congested router.

7. Method according to either of claims 5 and 6, characterised in that the given condition at step b2) includes the fact that the router is one of the routers on a given pathway defined by a traffic class.

8. Method according to any of the foregoing claims, characterised in that step a) includes, for each router, a capacity value (C, A1-2), a buffer memory size value (B, A1-3), a type indication (RT, A1-5), together with values for pure propagation time between routers.

9. Method according to any of the foregoing claims, characterised in that step a) includes, for each traffic class, a number of sources per class (SN, A2-3), a pathway from a source to a destination (SR, A2-4), a type indication (ST, A2-2), together with values for propagation time between a source and an access router (SB, A2-5) on one hand, and between a terminal access router and a destination (SE, A2-6) on the other hand.

10. Method according to any of the foregoing claims, characterised in that the traffic evolution model at step b) includes variables including the number of sources using a given router (N[r], A3-3), a round-trip time (rtt, A3-4) of a defined class from the source to the destination.

11. Method according to any of the foregoing claims, characterised in that the traffic evolution model at step b) includes variables defined according to initial conditions, these variables including an average value of the throughput rate of a router, a value that can theoretically be used for each source sharing this router (c(r), B0-2), a proportion value representing a number of sources in a class relative to the total number of sources sharing a router (a(s,r), B0-3), an acceleration value for a router (m-rtt[r], B0-4) representing the sum for the classes of the ratio of the proportion value to a round-trip time from the source to the destination squared, a synchronisation rate (p, C1-1; C2-1).

12. Method according to any of the foregoing claims, characterised in that step b2) includes a mathematical formulation essentially conforming to Appendix B1-3.

13. Method according to claim 10, characterised in that the synchronisation rate is estimated independently of the rate.

14. Method according to claim 13, characterised in that the synchronisation rate is estimated in a manner conforming to the mathematical formulation presented in Appendix C1-1 including a probability L of packet loss.

15. Method according to claim 10, characterised in that the synchronisation rate (p) is estimated in accordance with the mathematical formulation in Appendix C1-1 in a manner dependent on the rate.

16. Method according to claim 15, characterised in that the synchronisation rate (p) is estimated in accordance with the mathematical formulation in Appendix C2-1 including a probability of packet loss L.

17. Method according to claim 12 and 14, characterised in that the probability of packet loss L is estimated in accordance with the mathematical formulation in Appendix C1-2.

18. Method according to either of claims 15 and 16, characterised in that the probability of packet loss L is estimated in accordance with the mathematical formulation in Appendix C3-1.

19. Method according to any of the foregoing claims, characterised in that the synchronisation rate is calculated by independent simulation.

20. Method according to any of the foregoing claims, characterised in that the session represents a flow controlled by a protocol of the type TCP.

21. Method according to claim 3, characterised in that step b) includes being performed iteratively for each router and for each class.

22. Device for testing and predicting the behaviour of a computer network, characterised in that it includes:
a memory (4) designed to store:
parameters of the network (8) including routers (r), their specific transmission properties (C, A1-2), and transit times between routers,
usage configuration parameters of the network (9) including traffic classes, each of these classes being associated with a number of sources (SN, A2-3) and a pathway through the routers (SR, A2-4),
a calculation module (5) based on a traffic evolution model of the additive increase and multiplicative decrease type (AIMD),
a processing module (3) designed:
on the basis of selected initial conditions, to iteratively apply a traffic evolution model, of the additive increase and multiplicative decrease type (AIMD), to simulate the evolution of throughput rates in the network, in each instance storing a set of class or source rate variables (1),
to halt the iterative application of the traffic evolution model when a periodic orbit reverting substantially to a set of class or source rate variables (I) already encountered is obtained,
to examine the series of routers encountered as responsible for losses to evaluate the rate obtained by each class or source.

23. Device according to claim 22, characterised in that the processing module (3) is designed to stop the iterative application of the traffic evolution model when the number of iterations reaches a threshold.

24. Device according to either of claims 22 and 23, characterised in that the processing module (3) is designed to compute and store a virtual inter-congestion time (tau_n[r], A3-6) for each router.

25. Device according to claim 24, characterised in that the processing module is designed to compute and store a minimum virtual inter-congestion time, as the effective inter-congestion time of the network (tau_n, A3-5).

26. Device according to either of claims 24 and 25, characterised in that the processing module is also designed to compute and store rate values of classes whose pathway passes through a congested router (x_n[s], X_n[s]).

27. Device according to claim 26, characterised in that the chosen router is selected so that it verifies a given condition, which includes the fact that the inter-congestion time of the network (tau_n, A3-5) is equal to the virtual inter-congestion time (tau_n[r], A3-6) for that router.

28. Device according to claim 27, characterised in that the given condition includes the fact that the router is one of the routers on a given pathway defined by a traffic class.

29. Device according to any of the foregoing claims, characterised in that each router includes a capacity value (C, A1-2), a buffer memory size value (B, A1-3), a type indication (RT, A1-5), together with values for pure propagation time between routers.

30. Device according to any of the foregoing claims, characterised in that each traffic class includes a number of sources per class (SN, A2-3), a pathway from a source to a destination (SR, A2-4), a type indication (ST, A2-2), together with values for propagation time between a source and an access router (SB, A2-5) on one hand, and between a terminal access router and a destination (SE, A2-6) on the other hand.

31. Device according to any of the foregoing claims, characterised in that the traffic evolution model includes variables including the number of sources using a given router (N[r], A3-3), a round-trip time (rtt, A3-4) of a defined class from the source to the destination.

32. Device according to any of the foregoing claims, characterised in that the traffic evolution model includes variables defined according to initial conditions, these variables including an average value of the throughput rate of a router, a value that can theoretically be used for each source sharing this router (c(r), B0-2), a proportion value representing a number of sources in a class relative to the total number of sources sharing a router (a(s,r), B0-3), an acceleration value for a router (m-rtt[r], B0-4) representing the sum for the classes of the ratio of the proportion value to a round-trip time from the source to the destination squared, a synchronisation rate.

33. Device according to claim 12, characterised in that the computation and storage of rate values for classes whose pathway passes through a congested router (x_n[s]=X_n[s]) is carried out according to a mathematical formulation essentially conforming to Appendix B1-5.

34. Device according to claim 10, characterised in that the synchronisation rate is estimated independently of the rate.
